(19) United States
(12) Patent Application Publication
(10) Pub. No.: US 2015/0251181 A1
(43) Pub. Date: Sep. 10, 2015

(54) MICRO-CHANNEL DEVICE

(71) Applicant: CANON KABUSHIKI KAISHA, Tokyo (JP)

(72) Inventor: Tomohiro Saito, Utsunomiya-shi (JP)

(21) Appl. No.: 14/632,077

(22) Filed: Feb. 26, 2015

(30) Foreign Application Priority Data
Mar. 4, 2014 (JP) 2014-041379

(51) Int. Cl. B01L 3/00

(52) U.S. Cl. CPC B01L 3/502723; B01L 3/50273; B01L 2200/0684; B01L 2400/0475

(57) ABSTRACT

A micro-channel device has a micro-channel for flowing liquid therethrough and includes a first aperture held in communication with the micro-channel for the purpose of injecting liquid, a second aperture held in communication with the micro-channel for the purpose of discharging liquid and a bubble trapping region constituting a part of the micro-channel. The height of the bubble trapping region is greater than the height of the micro-channel at the position of liquid inflow into the micro-channel located downstream relative to the bubble trapping region.

### BACKGROUND OF THE INVENTION

1. Field of the Invention

The present invention relates to a micro-channel device.

2. Description of the Related Art

A variety of devices and sensors have been and are being developed in order to acquire the information on the processes of biochemical reactions and the results of chemical analyses. Micro-devices having a micro-structure such as a micro-channel having a predetermined flow channel profile that is formed in two or more than two substrates have been proposed as such devices. Such micro-devices can be further downsized because they can be manufactured by utilizing semiconductor manufacturing techniques and other relevant techniques. Furthermore, such micro-devices allow all the analytical process down to acquiring desired information to be executed on the micro-device.

A device of the above-identified type is referred to as a micro total analysis system (μ-TAS) or a lab-on-a-chip. Particularly, a device having a micro-structure such as a micro-channel formed in a substrate is referred to as a micro-channel device.

If compared with conventional desk top equipment, the quantity of the liquid that a micro-channel device can contain is very small. In other words, the liquid containing capacity of a micro-channel device is very small to provide an advantage of reducing the quantity of the reagent required for a chemical analysis and also reducing the reaction time because of the required quantity of the object of analysis that is reduced to the micron level.

A micro-channel device generally includes at least two or more than two substrates. A micro-groove is formed on one of the surfaces of one of the substrates and a micro-channel is produced as another one of the substrates is bonded to the surface of the first substrate where the groove is formed.

When a heater (resistor) is arranged in the micro-channel and the fluid flowing through the micro-channel is heated by the heater, the temperature of the fluid can be raised and lowered quickly because the thermal capacity of the fluid is small and hence the fluid sensitively follows the temperature of the heater. Therefore, for example, a polymerase chain reaction (PCR) of DNA can be made to take place and become completed in a short period of time by using such a micro-channel device. The reaction product produced in the micro-channel as a result of the reaction is generally evaluated within the channel by means of an optical sensor. For instance, the status of the ongoing reaction and the quantity of the reaction product can be observed by irradiating the reaction product with light of a specific wavelength and catching the fluorescence emitted from the reaction product.

Micro-channel devices having a micro-channel in the inside are subjected to various influences to a large extent by the foreign object or objects allowed to intrude into the micro-channel because the flow channel of the device is very small. Particularly, when one or more than one bubbles are allowed to intrude into a micro-channel such as a reaction zone of a PCR device, a problem of temperature unevenness arises so that the intended reaction product may not be produced. Besides, if one or more than one bubbles are allowed to intrude into the optical sensor section of the micro-channel device, the bubbles hinder the emission of fluorescence so that the spectral intensity may not accurately be observed.

In view of the above-identified problem, a number of proposals have been made to realize a flow channel structure capable of removing the bubbles that have intruded into the micro-channel.

Japanese Patent Application Laid-Open No. 2013-7592 proposes a micro-channel structure having undulations formed on part of the channel wall surface so as to trap bubbles in the undulations and prevent bubbles from intruding into the part of the flow channel located downstream relative to the undulations.

However, with the structure of the above-cited patent document, when bubbles are allowed to continuously intrude into the flow channel, the bubbles keep on remaining in the trap and the trap will eventually be saturated with bubbles. Once the trap becomes saturated with bubbles, the structure can no longer eliminate bubbles.

Japanese Patent Application Laid-Open No. 2011-99724 proposes a micro-channel structure having a bubble discharging flow channel with an orifice diameter greater than the diameter of the proper micro-channel and branched from the proper micro-channel so as to guide bubbles from the proper micro-channel into the bubble discharging flow channel.

The structure of the above-cited patent document can remove bubbles if a large number of bubbles intrude into the proper micro-channel. However, if bubbles having a diameter smaller than the diameter of the bubble discharging flow channel intrude into the flow channel, some or all of them can get into the proper micro-channel at the branching point.

Japanese Patent Application Laid-Open No. 2002-527250 proposes a micro-channel structure having a gas ventilation channel for degassing. The proper micro-channel through which liquid flows is held in contact with the gas ventilation channel by way of a hydrophobic throttle and liquid cannot pass through the throttle although gas can pass through the throttle.

With the structure of the above-identified patent document, the boundary of the gas phase part and the liquid phase part simply runs in parallel with the liquid flow direction in the micro-channel and therefore the gas-liquid interface can be engulfed by the liquid flow to generate bubbles afresh. Additionally, since the position of the gas ventilation channel is not particularly specified, bubbles can simply pass through without being brought into contact with the gas-liquid interface depending on the position where the gas ventilation channel is arranged.

### SUMMARY OF THE INVENTION

The present invention provides a device designed to eliminate bubbles of various different sizes that have intruded into the liquid that is running through a micro-channel from the micro-channel and prevent bubbles from intruding into the reaction region and the optical examination region in the device.

In an aspect of the present invention, there is provided a micro-channel device having a micro-channel for flowing liquid therethrough, the device including: a first aperture held in communication with the micro-channel for the purpose of injecting liquid; a second aperture held in communication with the micro-channel for the purpose of discharging liquid; and a bubble trapping region constituting a part of the micro-channel; the height of the bubble trapping region being greater than the height of the micro-channel at the position of liquid inflow into the micro-channel located downstream relative to the bubble trapping region.

Thus, according to the present invention, the bubbles that intrude into the micro-channel are caught at the gas-liquid interface in the bubble trapping region and merged with the gas-liquid interface. The gas that constitutes the bubbles is discharged by way of the air passage formed at the bubble trapping region and hence no bubbles will be released back into the micro-channel from the gas-liquid interface. Then, as a result, bubbles can reliably be eliminated from the flow channel regardless of the sizes and the volumes of the bubbles trapped in the bubble trapping region and therefore are prevented from intruding into the reaction region and the optical examination region of the device.

Further features of the present invention will become apparent from the following description of exemplary embodiments with reference to the attached drawings.

### BRIEF DESCRIPTION OF THE DRAWINGS

FIG. 1 is a schematic top view of an embodiment (EXAMPLE 1) of a micro-channel device according to the present invention.

FIG. 2A is a schematic cross-sectional view of the micro-channel device of FIG. 1 taken along line 2A-2A.

FIG. 2B is a schematic cross-sectional view of the micro-channel device of FIG. 1 taken along line 2B-2B.

FIG. 3 is a schematic illustration of the micro-channel device according to the present invention that is in a state of being driven to operate.

FIG. 4 is a schematic top view of the micro-channel device according to EXAMPLE 2 of the present invention.

FIG. 5A is a schematic cross-sectional view of the micro-channel device of FIG. 4 taken along line 5A-5A.

FIG. 5B is a schematic cross-sectional view of the micro-channel device of FIG. 4 taken along line 5B-5B.

FIG. 6 is a schematic top view of the micro-channel device according to EXAMPLE 3 of the present invention.

FIG. 7A is a schematic cross-sectional view of the micro-channel device of FIG. 6 taken along line 7A-7A.

FIG. 7B is a schematic cross-sectional view of the micro-channel device of FIG. 6 taken along line 7B-7B.

### DESCRIPTION OF THE EMBODIMENTS

Now, the present invention will be described in greater detail by way of embodiments.

A micro-channel device is a device having a micro-channel and a micro-channel is a flow channel having a width smaller than 1 mm (1,000 μm) and designed to flow a liquid material such as a solution containing water and one or more organic substances in the inside thereof. A micro-channel can be produced by bonding a substrate having a microgroove on one of the surfaces thereof with another substrate so as to cover the groove. A micro-channel may typically have a width of not greater than 1,000 μm and a depth of not greater than 500 μm. The flow of a solution in the micro-channel may be a turbulent flow or a laminar flow. When, however, the flow is a laminar flow, the solution can be prevented from unnecessarily agitated so that the reaction in the flow channel can be more accurately controlled.

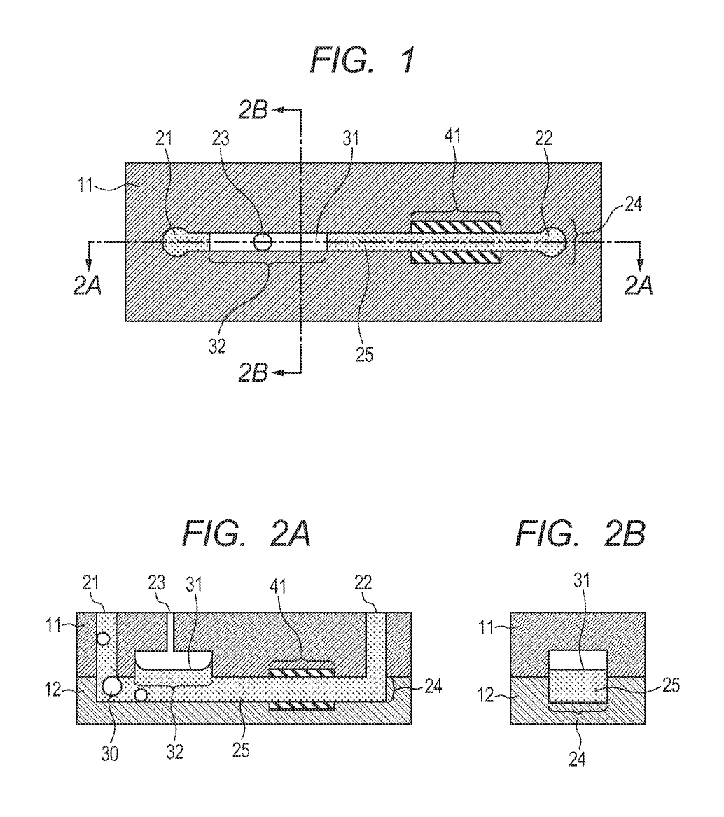

FIG. 1 is a schematic top view of the micro-channel device according to an embodiment of the present invention. FIG. 2A is a schematic cross sectional view of the micro-channel device taken along line 2A-2A. FIG. 2B is a schematic cross-sectional view of the micro-channel device taken along line 2B-2B. The micro-channel device of this embodiment includes a second substrate 12 where a micro-channel 24 is formed and a first substrate 11 bonded to the second substrate 12 so as to cover the micro-channel 24. The first substrate and the second substrate are bonded to each other typically by way of an adhesive agent or by direct bonding such that the entire flow channel is enclosed at least by wall surfaces so that any part of the fluid flowing through the micro-channel 24 would not leak out. The first substrate 11 is provided with a liquid injection port 21 and a liquid discharge port 22 that are apertures at which the micro-channel 24 is exposed to the outside. The joining surface of the first substrate 11 has a recess at least in a part of the region that is disposed vis-à-vis the micro-channel 24 formed in the second substrate such that, as the first substrate 11 is bonded to the second substrate 12, the recess becomes a bubble trapping region 32 having a concave profile adapted to seize the bubbles that have intruded into the micro-channel 24. After the first and second substrates are bonded to each other, as the inside of the micro-channel 24 is filled with liquid 25, a gas-liquid interface 31 is produced in the bubble trapping region 32 as the interface between the liquid 25 in the micro-channel and the gas at the outside. A through hole running all the way from the recess to the opposite surface of the first substrate 11 may be formed in the first substrate 11 so as to make it operate as air passage, which will be described in greater detail hereinafter.

Now, the configuration and the component members of the micro-channel device will be described below.

There are no particular limitations to the materials that can be used for the first and second substrates. Examples of materials that can be used for the first and second substrates include glass, plastic, metal and inorganic compounds. Examples of glass that can be used for the first and second substrates include quartz glass, alkali glass and non-alkali glass. Examples of plastic that can be used for the first and second substrates include acryl resin, polyethylene, polypropylene, polyvinyl chloride, polystyrene and nylon. Either only a single kind of plastic or two or more different kinds of plastic may be used for the first and second substrates.

Examples of metal that can be used for the first and second substrates include aluminum, nickel, iron, copper and alloys such as stainless steel and brass. Examples of inorganic compounds that can be used for the first and second substrates include metal oxides such as alumina, zirconia, silica and a mixture of any of them as well as ceramic materials such as boron nitride.

There are no particular limitations to the method of manufacturing substrates to be used for the purpose of the present invention. A delicate micro-channel can highly accurately be formed in a substrate by means of etching, machining or metal molding. Particularly, a micro-channel device can be formed highly accurately by etching when glass, metal or an inorganic compound is used for the substrates of the device. Similarly, micro-channel devices can be formed highly accurately on a mass production basis by injection molding when a plastic material is used for the substrates of the devices.

There are no particular limitations to the thickness of the substrates to be used for the purpose of the present invention. The reaction to be induced to take place in the flow channel of a micro-channel device according to the present invention can highly accurately be controlled by selecting an appropriate thickness for the substrates of the device that does not allow the substrates to be deformed by pressure of the liquid 25 flowing in the inside of the micro-channel. For example, when the substrates are made of a plastic material, the substrates desirably have a thickness of not less than 0.1 mm. When the thickness is less than 0.1 mm, the substrates can be deformed by the pressure of the liquid 25 flowing in the inside of the micro-channel to consequently obstruct the operation of controlling the pressure of the solution. The upper limit value of the thickness of the substrates is not particularly defined for the purpose of the present invention. An optimum thickness may be selected by considering the profile of the products, the manufacturing yield and the manufacturing cost.

A gas-liquid interface 31 along which the liquid flowing through the micro-channel (which may also be referred to as “flow channel” hereinafter) 24 contacts gas is produced in the inside of the bubble trapping region 32. For this reason, the bubble trapping region 32 is designed so as to have a height greater than the height of the flow channel 24 located both upstream and downstream relative to the bubble trapping region 32. The height of the flow channel 24 or that of the bubble trapping region 32 of a micro-channel device according to the present invention is defined as follows. Assume that the micro-channel device is placed on a horizontal plane with the second substrate located under the first substrate and the flow channel is subjected to the Earth's gravity. The direction in which the gravity is directed is defined to be the bottom surface side and the opposite direction is defined to be the top surface side. Then, the distance from the horizontal plane that includes the bottom surface of the second substrate to the point located highest at the top surface side of the flow channel 24 or the bubble trapping region 32 (and hence the apex of the flow channel 24 or that of the bubble trapping region 32, whichever appropriate) is the height of the flow channel 24 or the bubble trapping region 32, whichever appropriate. Additionally, the vertical inner diameter and the horizontal inner diameter of the flow channel 24 are respectively defined as the vertical width and the horizontal width of the flow channel. In this embodiment, the bubble trapping region 32 is arranged at the side same as the side where the liquid injection port 21 and the liquid discharge port 22 are arranged relative to the flow channel 24. The bubble trapping region 32 is produced by forming a groove-shaped recess in part of the region of the first substrate 11 that is located vis-à-vis the micro-channel 24 and bonding the first substrate 11 and the second substrate 12 together. While there are no particular limitations to the method of forming the recess, it may typically be formed by dry or wet etching, machining using one or more drills or injection molding using one or more metal molds.

While there are no particular limitations to the width of the bubble trapping region 32, the bubble trapping region 32 can trap bubbles from the entire flow channel when the bubble trapping region 32 has a width same as or greater than the width of the flow channel. Note that, when the bubble trapping region 32 is made to represent a tapered cross section so as to be wider at the flow channel side and become narrower as a function of the distance from the flow channel, the bubbles caught in the bubble trapping region 32 become densely populated as they rise upward so that bubbles will easily be captured in an upper part of the region.

The bubble trapping region 32 is provided with an air passage 23 that communicates with the outside in terms of air flow. A valve or the like may be arranged at the air passage 23 so as to selectively produce a state where the bubble trapping region 32 communicates with the outside or a state where the bubble trapping region 32 does not communicate with the outside. Note, however, a state where the bubble trapping region 32 does not communicate with the outside may alternatively be produced by means of a gas-liquid interface holding pump 52, which will be described in greater detail hereinafter. In short, there are no particular limitations to the arrangement for producing a state where the bubble trapping region 32 does not communicate with the outside. A gas-liquid interface 31 is formed at the height that equilibrates the external air pressure that gets in through the air passage 23 and the pressure of the liquid 25 flowing in the inside of the flow channel 24. The bubble trapping region 32 is desirably so formed that no liquid 25 will leak to the outside from the air passage 23 and the gas-liquid interface 31 is located in the inside of the bubble trapping region 32. When the flow channel is so designed that the top of the flow channel 24 is located below the gas-liquid interface 31 in the part of the flow channel 24 that is located immediately downstream relative to the bubble trapping region 32 where liquid flows into the flow channel 24, the air found above the gas-liquid interface 31 is prevented from being forced to flow downstream by the flow of the liquid 25 in the micro-channel 24. Additionally, the vertical width of the bubble trapping region 32 is desirably greater than the vertical width of the part of the flow channel 24 located downstream relative to the bubble trapping region 32. All in all, the vertical width of the micro-channel device may appropriately be selected according to the purpose of the use of the micro-channel device. While there are no particular limitations to the vertical width and the horizontal width of the micro-channel 24, bubbles can efficiently be collected when the ratio of the vertical width to the horizontal width (vertical width/horizontal width) is not greater than 1.

When the vertical width of the micro-channel 24 is made smaller than the distance necessary for the bubbles in the liquid 25 to rise from the bottom of the flow channel to the gas-liquid interface 31 while the liquid 25 is passing through the bubble trapping region 32, the bubbles 30 can more reliably be caught because the bubbles in the liquid 25 go upward by the buoyancy thereof and eventually get into contact with the gas-liquid interface 31 in the bubble trapping region 32. The final velocity of a particle (a bubble in this case) in liquid is known to be expressed by Stalks formula shown below:

V_{f}=2g(ρ_{A}−ρ_{W})r²/9μ (formula 1),

where V_{f} is the final velocity, g is the gravitational acceleration, μ is the fluid viscosity, r is the radius of the bubble, ρ_{A} is the bubble density and ρ_{W} is the liquid density.

From the formula 1, if, for example, the fluid is water and the bubble is an air bubble, the floating up velocity (final velocity) of a bubble having a diameter of 10 μm will be about 0.24 mm/sec. If the distance from the bottom of the flow channel 24 to the gas-liquid interface 31 is 50 μm and the bubble 30 is located at the bottom of the flow channel at the beginning, the bubble can come to contact the gas-liquid interface in about 0.21 sec. The position at which the bubble comes to contact the gas-liquid interface in the bubble trapping region can be determined by calculations using the velocity of the flowing liquid and hence the length required to the bubble trapping region 32 can be estimated. When, for example, the above-described bubble 30 is to be caught and if the liquid 25 is flowing at a velocity of 6 mm/sec, the bubble trapping region 31 is required to have a length of not less than about 1.26 mm. Conversely, if the length of the bubble trapping region 31 is not less than 1.26 mm, the pressure of the feed pump for feeding liquid may be so adjusted that the liquid 25 may flow at a velocity smaller than 6 mm/sec.

Now, the liquid feed system of the micro-channel device will be described below.

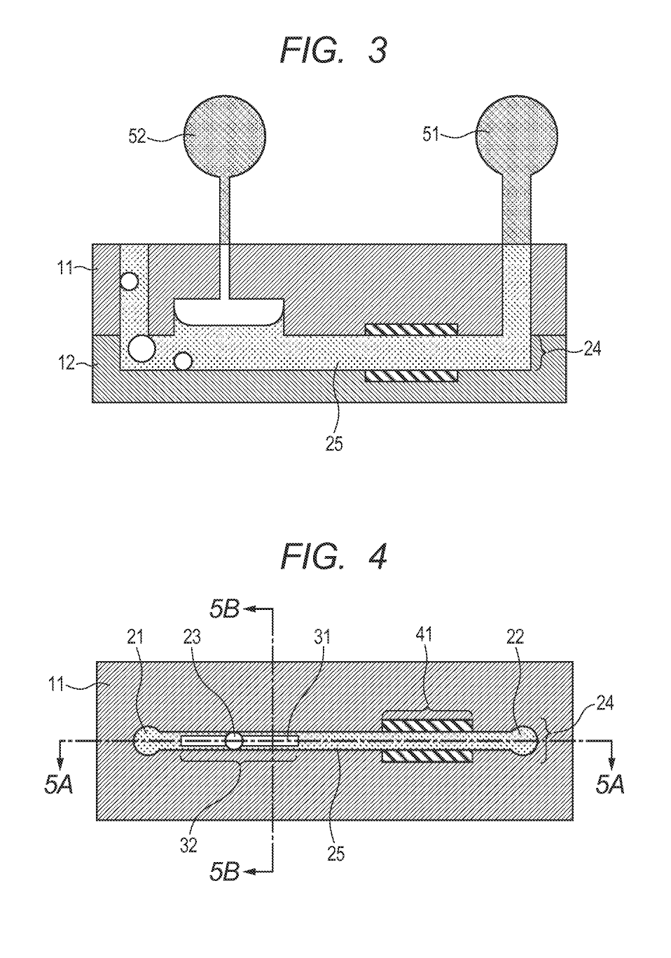

A feed pump 51 for driving the liquid in the inside of the micro-channel 24 to flow may be connected to the liquid discharge port 22 as illustrated in FIG. 3 for the purpose of driving the liquid 25 in the micro-channel to flow. Then, the liquid discharge port 22 is depressurized by the pump so that the liquid 25 in the flow channel 24 is pushed to flow in the inside of the flow channel 24 under the atmospheric pressure that is being applied to the liquid injection port 21. Conversely, a feed pump for driving the liquid in the inside of the micro-channel 24 to flow may be connected to the liquid injection port 21 in order to pressurize the liquid injection port 21 by means of the pump. When the connected pump 51 can control a minute flow rate in the micro-channel 24, the flow of the liquid 25 in the inside of the micro-channel 24 can be controlled more accurately. While there are no limitations to the pump to be used, the use of a peristaltic pump (micro tubing pump) may be preferable for the purpose of the present invention. Such a pump may appropriately be selected by considering the size of the flow channel 24 of the micro-channel device to be used with the pump, the target flow rate and so on. A pressure sensor may be connected to the pump in order to detect the pressure within the piping. The use of a pressure sensor is necessary in order to monitor the pressure in the bubble trapping region and the air passage and properly driving a gas-liquid interface holding pump 52 to operate. A pressure sensor that can detect the low pressure in the inside of the micro-channel is desirably employed.

A gas-liquid interface holding pump 52 that is independent from the feed pump 51 may be connected to the air passage 23. The position of the gas-liquid interface 31 in the inside of the bubble trapping region 32 can be maintained to a constant level by using such a pump 52. As fluid 25 flows in the inside of the micro-channel 24 toward the liquid discharge port 22, the gas-liquid interface 31 is pulled down by the liquid 24 in the flow channel to consequently reduce the pressure in the bubble trapping region 32. The negative pressure produced by the pressure reduction is expressed by formula 2 shown below:

P₂=½×ρQ²(1/A₁²−1/A₂²)+P₁ (formula 2),

where P₁ is the pressure of the feed pump, P₂ is negative pressure produced by the flow of fluid, Q is the flow rate of liquid, A₁ is the cross-sectional area of the micro-channel, A₂ is the cross sectional area of the bubble trapping region and ρ is the density of the flowing fluid.

As a bubble 30 contacts another bubble 30, they tend to become unified in order to minimize the surface area of the two bubbles. Generally, bubbles can easily be unified when the surface tension of the liquid being used is small. Additionally, once a bubble contacts the gas-liquid interface, the bubble tends to be held there due to the surface tension of the liquid. So long as the force applied by the liquid 25 flowing in the inside of the micro-channel 24 and trying to pull out the bubble 30 is smaller than the adhesion force between the bubble 30 and the gas-liquid interface 31, the bubble 30 remains at the gas-liquid interface 31 and would not leave the gas-liquid interface 31. The bubbles contacting the gas-liquid interface 31 desirably remain at the gas-liquid interface until they become unified.

The adhesion force of a bubble trying to adhere to the gas-liquid interface is expressed by formula 3 shown below on the basis of surface tension. Thus, the force required for a bubble trapped at the gas-liquid interface to remain there can be determined by using the formula 3:

F=2πrγ sin θ (formula 3),

where F is the adhesion force of the bubble relative to the gas-liquid interface, γ is the surface tension, r is the radius of the bubble and θ is the wetting angle of the bubble.

When the pressure of the liquid 25 in the inside of the micro-channel 24 that is exerted on the bubble 30 is smaller than the adhesion force of the bubble 30 relative to the gas-liquid interface 31 as determined by the formula 3, the bubble 30 keeps on being trapped at the gas-liquid interface 31. The equilibrium between the pressure of the liquid 25 in the inside of the micro-channel 24 that is applied to the bubble 30 and the adhesion force of the bubble 30 relative to the gas-liquid interface 31 can be determined by calculations, taking moment into consideration. Assume here that the force exerted to the bubble is P, the adhesion force of the bubble relative to the gas-liquid interface is F, the surface tension is γ, the radius of the bubble is r and the wetting angle of the bubble is θ.

So long as the moment of the adhesion force F relative to the gas-liquid interface with respect to the center of the bubble is greater than the moment of the pressure P being applied to the bubble with respect to the center of the bubble, the bubble is not released from the gas-liquid interface. This is expressed by formula 4 shown below:

P×r≦F×r (formula 4),

and hence the conditions that satisfy the above formula are the conditions for holding the bubble in position.

The pressure being applied by the liquid to the bubble is equal to the pressure P₁ of the feed pump. Assume here that the pressure is applied to ¼ of the surface area of the bubble. Then, as the left side of the formula 4 is multiplied by ¼ of the surface area of the bubble while the right side of the formula 4 is substituted by the formula 3, formula 5 and formula 6 will be derived:

πr²P₁≦2πr²γ sin θ (formula 5) and

P₁≦2γ sin θ/r (formula 6).

Formula 7 shown below can be obtained by expressing the pressure P₁ of the liquid expressed by the above formulas by means of the parameters constituting the flow channel. Note that Q is the flow rate of the liquid, A₁ is the cross sectional area of the micro-channel, A₂ is the cross sectional area of the bubble trapping region and ρ is the density of the liquid.

P₂=½×ρQ²(1/A₁²−1/A₂²)+P₁ (formula 7)

½×ρQ²(1/A₁²−1/A₂²)+P₁≦2γ sin θ/r (formula 8)

Liquid can be made to flow in the inside of the micro-channel without releasing the bubble from the gas-liquid interface in the bubble trapping region by adjusting the flow rate Q and the cross sectional areas A₁ and A₂, namely the velocity of the flowing liquid (v=Q/A), so as to make them satisfy the requirement of the formula (8).

Now, calculations will be made by using specific numerical values for the formula 8. When the cross-sectional areas A₁ and A₂ of the flow channel are 0.014 mm² (horizontal width: 180 μm, vertical width: 80 μm) and 0.0036 mm² (horizontal width: 180 μm, vertical width: 20 μm) respectively, the flow rate Q is 6 nL/sec, the liquid density ρ is 1.0 g/cm², the surface tension of the liquid is 0.072 N/m, the radius of the bubble is 10 μm, the contact angle of the bubble and the gas-liquid interface is 45° and the pressure P₂ is 0.1 psi, the pressure is made smaller than the adhesion force F and hence the bubble is not released from the gas-liquid interface when a value not greater than 4.5 mm/sec is selected for the velocity of the flowing liquid in the bubble trapping region. In an experiment, liquid was made to flow through the flow channel having the above-described parameters to see if bubbles were released or not. As a result of the experiment, no bubbles that were released from the gas-liquid interface could be observed when the velocity of the flowing liquid was between 1.0 and 3.0 mm/sec.

Bubbles become unified in a state where bubbles contact each other by way of a thin film at the interfaces thereof when the film thickness fluctuates to make the surface tensions of the bubbles uneven and eventually break the films separating the bubbles. For this reason, the content of the surface active agent that is contained in the liquid to be used is preferably smaller than the content required for stabilizing the films separating the bubbles. When relatively pure liquid (and hence containing foreign object or objects such as surface active agents to only a small ratio) is employed, bubbles will be unified in a very short period of time. When the liquid is water and the bubbles are air bubbles, the time from the moment when the bubbles contact the gas-liquid interface between a gas phase, which is air, and a liquid phase, which is water, to the moment when the bubbles become unified is about 0.5 sec in average.

Now, the sequence of the operation of driving a micro-channel device according to the present invention will be described below.

A feed pump 51 and a gas-liquid interface holding pump 52 are connected to the micro-channel device. Firstly, liquid is injected into the device by way of the liquid injection port 21 and the feed pump 51 is driven to operate in order to fill the inside of the micro-channel 24 with liquid 25. At this time, the micro-channel 24, the bubble trapping region 32 and the air passage 23 are all filled with liquid 25.

Then, the operation of the feed pump 51 is stopped to cease the movement of the liquid 25 in the micro-channel 24 and subsequently the gas-liquid interface holding pump 52 is driven to operate. The gas-liquid interface holding pump 52 feeds gas from the outside of the micro-channel device into the bubble trapping region 32 by way of the air passage 23 to produce a gas-liquid interface 31 in the bubble trapping region 32.

As the feed pump 51 is driven to operate again in this state and move liquid 25 in the micro-channel 24, the pressure in the bubble trapping region 32 and also the pressure in the air passage 23 fall due to the Venturi effect. At this time, the valve at the air passage 23 is closed so as to shut the air passage 23. The pressure in the air passage 23 at this time is defined as reference pressure. As bubbles 30 are trapped at the gas-liquid interface 31, the position of the gas-liquid interface 31 falls so that the cross sectional area of the bubble trapping region 32 is reduced to by turn increase the velocity of the liquid flowing in the bubble trapping region 32. Then, as a result, the pressure in the air passage 23 falls. When the pressure in the air passage 23 falls below the above-defined reference pressure, the gas-liquid interface holding pump 52 is driven to operate and restore the reference pressure in the air passage 23. Thus, the gas-liquid interface returns to the original level.

As a result of the above sequence of operation, the device can keep on trapping bubbles 30, while maintaining the gas-liquid interface 31 to a constant level by driving the gas-liquid interface holding pump 52 to operate, referring to the pressure in the air passage 23, even when bubbles 30 are trapped at the gas-liquid interface 31 to change the level of the gas-liquid interface 31.

A micro-channel device according to the present invention can find applications in the field of medical examination elements to be used for medical examinations and diagnoses. However, the field of application of the present invention is by no means limited to that of medical examination elements and can further find applications broadly in various technical fields of elimination of bubbles from devices having a micro-channel.

### Example 1

Now, the present invention will be described further in greater detail by way of examples. Micro-channel devices were prepared in the examples that will be described below by applying the arrangement described above for the embodiments.

Quartz substrates were brought in as the material of the substrates to be used in this example and substrates having respective profiles as illustrated in FIGS. 1, 2A and 2B were obtained. Each of the substrates had a width of 60 mm, a depth of 30 mm and a thickness of 0.6 mm. The obtained substrates included the second substrate 12 having a groove (horizontal width: 180 μm, vertical width: 20 μm) that eventually became a micro-channel 24 and the first substrate 11 having a liquid injection port 21 (diameter: 0.35 mm), a liquid discharge port 22 (diameter: 0.35 mm), a recess (horizontal width: 180 μm, vertical width: 80 μm, length: 5 mm) that eventually became a bubble trapping region 32 and had a profile matching the profile of the groove of the second substrate 12 and a gas passage 23 (diameter: 0.35 mm).

The prepared first and second substrates were put together by direct bonding of quarts substrates. A BOND MEISTER NWB (trade name) available from Mitsubishi Heavy Industries was employed for the bonding.

Pumps (400FD (trade name) available from WATSON MARLOW) were connected to the device obtained as a result of the bonding respectively at the liquid discharge port 22 and the air passage 23. Rubber tubes were used to connect the pumps to the respective apertures and the tubes and the apertures of the micro-channel device were connected to each other by way of respective elastic sealing members. The employed pressure sensor was 20INCH-D-4 SENSOR (trade name) available from ALLSENSORS.

Distilled water was dropped through the liquid injection port 21 as liquid 25 by means of a pipette and a feed pump 51 was driven to operate in order to fill the inside of the micro-channel 24 with liquid 25. The feed pump 51 was driven to operate with suction pressure of about 0.12 psi and liquid 25 was fed at a rate of about 6.0 nL/sec. After the inside of the micro-channel 24 was filled with liquid 25, the operation of the feed pump 51 was stopped. After making sure that the liquid 25 in the micro-channel 24 was not moving, the gas-liquid interface holding pump 52 was driven to operate with pressure of about 0.06 psi to introduce external air from the air passage 23 to produce a gas-liquid interface 31 in the bubble trapping region 32.

Then, the feed pump 51 was driven to operate once again so as to feed liquid 25 in the flow channel 24, while maintaining the gas-liquid interface 31 at the same level. As the feed pump 51 was driven with pressure of about 0.12 psi to feed liquid 25 at a rate of about 6.0 nL/sec, suction pressure of about 0.05 to 0.07 psi was produced in the air passage 23 of the bubble trapping region 32. The pressure at this time was defined as reference level pressure of the gas-liquid interface.

A reagent was injected by means of a pipette, while keeping on feeding liquid. At this time, liquid was injected intermittently from the pipette in order to intentionally mix bubbles with liquid and produce air layers in the liquid.

As the bubbles were trapped at the gas-liquid interface 31 and became unified, the cross sectional area of the bubble trapping region 32 was visibly reduced and hence the pressure in the inside of the air passage 23 kept on falling. When the pressure fell under about 0.04 psi, the gas-liquid interface holding pump 52 was driven to operate so as to control the pressure and make it equal to 0.07 psi that was initially selected as the reference pressure.

As a result, the bubbles 30 that got into the micro-channel 24 were trapped at the gas-liquid interface of the bubble trapping region 32. Then, the bubbles became unified and discharged from the air passage 23 to the outside by way of the gas-liquid interface holding pump 52. Consequently, no bubbles were observed in the reaction/detection region 41 provided downstream relative to the bubble trapping region 32 in the micro-channel 24 for reaction and/or detection purposes.

### Example 2

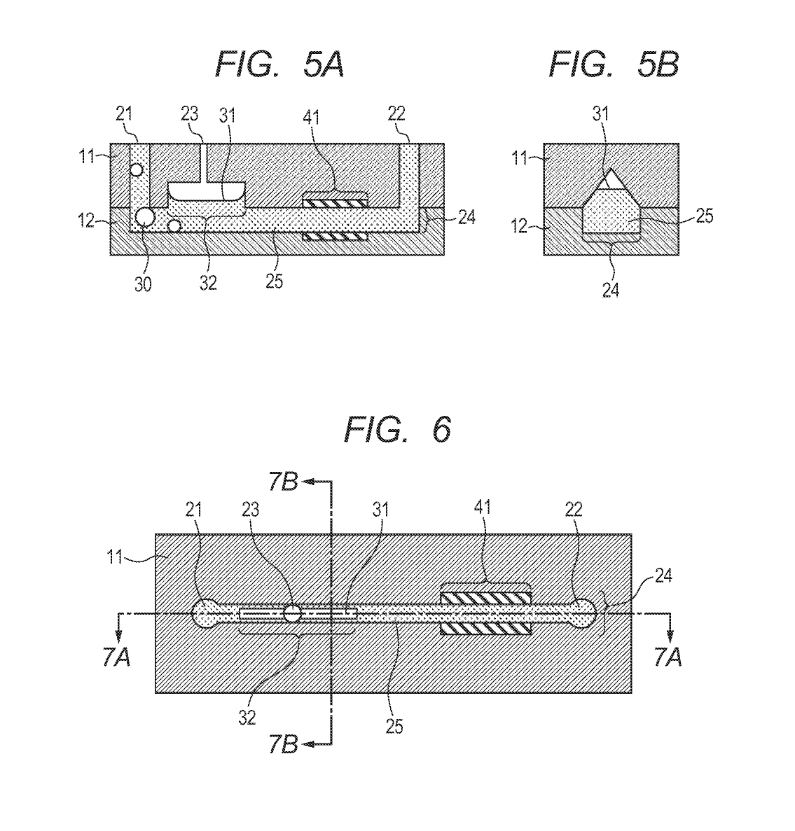

Quartz substrates were brought in as the material of the substrates to be used in this example and substrates having respective profiles as illustrated in FIGS. 4, 5A and 5B were obtained by dry etching. Each of the obtained substrates had a width of 60 mm, a depth of 30 mm and a thickness of 0.6 mm. The obtained substrates included the second substrate having a groove 24 (horizontal width: 180 μm, vertical width: 20 μm) that eventually became a micro-channel and the first substrate 11 having a liquid injection port 21 (diameter: 0.35 mm), a liquid discharge port 22 (diameter: 0.35 mm) and a gas passage 23 (diameter: 0.35 mm).

The bubble trapping region (horizontal width: 180 μm, vertical width: 80 μm, length: 3 mm) having a profile of running along the groove of the second substrate was made to represent a triangular cross section that was tapered in the height direction as illustrated in FIG. 5B by wet etching so as to produce a gas-liquid interface in an apex part of the triangle. (triangle with base: 180 μm and vertical width: 80 μm)

The substrates were bonded together in a manner same as the substrates of Example 1. As in Example 1, bubbles were intentionally mixed with liquid at the time of injecting a reagent by means of a pipette, while liquid was being fed, and how bubbles were trapped was observed.

As a result, as in Example 1, the bubbles that were mixed with liquid in the inside of the micro-channel were trapped at the gas-liquid interface 31 in the bubble trapping region 32 and became unified. Then, the unified bubbles were discharged from the air passage 23 by way of the gas-liquid interface holding pump 52 and no bubbles were observed in the reaction/detection region 41.

### Example 3

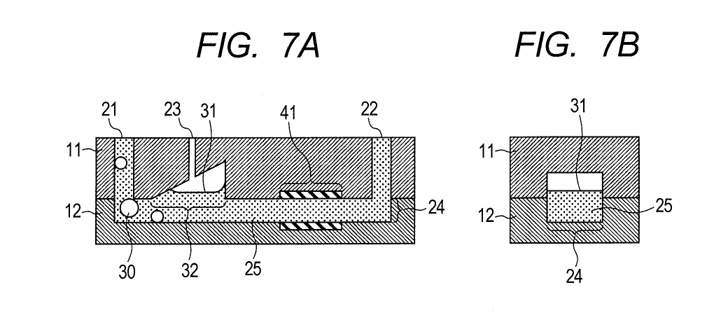

Quartz substrates were brought in as the material of the substrates to be used in this example and substrates having respective profiles as illustrated in FIGS. 6, 7A and 7B were obtained by dry etching. Each of the obtained substrates had a width of 60 mm, a depth of 30 mm and a thickness of 0.6 mm. The substrates included the second substrate having a groove 24 (horizontal width: 180 μm, vertical width: 20 μm) that eventually became a micro-channel and the first substrate 11 having a liquid injection port 21 (diameter: 0.35 mm), a liquid discharge port 22 (diameter: 0.35 mm) and a gas passage 23 (diameter: 0.35 mm).

The bubble trapping region (horizontal width: 180 μm, length: 3 mm) having a profile of running along the groove of the second substrate was made to represent a sloped cross section such that the height of the bubble trapping region 32 increased toward the downstream side by drilling so as to produce a gas-liquid interface 31 in an apex part of the sloped cross section. The slope was such that the vertical width increases to 80 μm for a horizontal length of 3 mm.

The substrates were bonded together in a manner same as the substrates of Example 1. As in Example 1, bubbles were intentionally mixed with liquid at the time of injecting a reagent by means of a pipette, while liquid was being fed, and how bubbles were trapped was observed.

As a result, as in Example 1, the bubbles that were mixed with liquid in the inside of the micro-channel were trapped at the gas-liquid interface 31 in the bubble trapping region 32 and became unified. Then, the unified bubbles were discharged from the air passage 23 by way of the gas-liquid interface holding pump 52 and no bubbles were observed in the reaction/detection region 41.

Currently preferable embodiments of micro-channel device according to the present invention are specifically described above. However, it should be noted here that the present invention is by no means limited to the above-described embodiments.

In a micro-channel device according to the present invention, the bubbles that intrude into the micro-channel are trapped at the gas-liquid interface in the bubble trapping region and become unified with the gas-liquid interface. The gas that forms the bubbles is discharged to the outside by way of the air passage of the bubble trapping region and no bubbles will be released again from the gas-liquid interface. Thus, as a result, bubbles can reliably be removed from the inside of the flow channel regardless of the size and the volume of the bubbles so that bubbles are prevented from intruding into the reaction region and/or the optical examination region.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of the Japanese Patent Application No. 2014-041379, filed Mar. 4, 2014, which is hereby incorporated by reference herein in its entirety.

What is claimed is:

1. A micro-channel device having a micro-channel for flowing liquid therethrough, the device comprising:
a first aperture held in communication with the micro-channel for the purpose of injecting liquid;
a second aperture held in communication with the micro-channel for the purpose of discharging liquid; and
a bubble trapping region constituting a part of the micro-channel;
the height of the bubble trapping region being greater than the height of the micro-channel at the position of liquid inflow into the micro-channel located downstream relative to the bubble trapping region.

2. The device according to claim 1, wherein
a feed pump is connected to the first aperture or the second aperture.

3. The device according to claim 2, wherein
the feed pump applies pressure P₁ that satisfies the requirement of formula 8 below to the liquid:
½×ρQ²(1/A₁²−1/A₂²)+P₁≦2γ sin θ/r (formula 8),
(where ρ is the density of the fluid, Q is the flow rate of the liquid, A₁ is the cross sectional area of the micro-channel, A₂ is the cross sectional area of the bubble trapping region, P₁ is the pressure of the feed pump, γ is the surface tension, r is the radius of the bubble and θ is the wetting angle of the bubble.)

4. The device according to claim 1, wherein
the bubble trapping region communicates with the outside by way of an air passage in terms of air flow.

5. The device according to claim 4, wherein
a gas-liquid interface holding pump is connected to the air passage.

6. The device according to claim 5, wherein
the gas-liquid interface holding pump applies pressure so as to make P₂ that is negative pressure satisfying the requirement of formula 2 below show a constant value:
P₂=½×ρQ²(1/A₁²−1/A₂²)+P₁ (formula 2),
(where P₁ is the pressure of the feed pump, Q is the flow rate of the liquid, A₁ is the cross sectional area of the micro-channel, A₂ is the cross sectional area of the bubble trapping region and ρ is the density of the fluid.)

7. The device according to claim 1, wherein
the height of the bubble trapping region increases toward the downstream side.

8. The device according to claim 1, wherein
the bubble trapping region has a tapered profile and the horizontal width thereof decreases as a function of the distance from the flow channel.

9. The device according to claim 1, wherein
the device has a reaction/detection region located downstream relative to the bubble trapping region in the flow channel.

10. A method of manufacturing a micro-channel device according to claim 4 by bonding the first substrate and the second substrate together, the method comprising:
a step of forming a groove on the surface of the second substrate to be bonded to the first substrate;
a step of forming an inwardly recessed profile at least in a part of the region corresponding to the groove of the second substrate on the surface of the first substrate to be bonded to the second substrate;
a step of forming a through hole running from the part having a recessed profile of the first substrate to the opposite surface of the first substrate; and
a step of bonding the first substrate and the second substrate together.

11. A liquid feed system of a micro-channel device comprising:
a micro-channel device according to claim 4;
a feed pump connected to the first aperture or the second aperture; and
a gas-liquid interface holding pump connected to the air passage.
